(19) United States
(12) Patent Application Publication
(10) Pub. No.: US 2015/0097953 A1
(43) Pub. Date: Apr. 9, 2015

(54) DEPLOYABLE CAMERA SYSTEM

(71) Applicant: GM GLOBAL TECHNOLOGY OPERATIONS LLC, Detroit, MI (US)

(72) Inventor: Paul B. Stambaugh, Dearborn, MI (US)

(73) Assignee: GM GLOBAL TECHNOLOGY OPERATIONS LLC, Detroit, MI (US)

(21) Appl. No.: 14/095,429

(22) Filed: Dec. 3, 2013

Related U.S. Application Data
(60) Provisional application No. 61/886,912, filed on Oct. 4, 2013.

(51) Int. Cl. H04N 5/225; H04N 7/18

(52) U.S. Cl. CPC H04N 5/2251; H04N 7/183
USPC 348/148

(57) ABSTRACT

A deployable camera system for a vehicle is provided and includes a camera movably mounted to the vehicle and a solenoid operably coupled between the camera and the vehicle.

### CROSS-REFERENCE TO RELATED APPLICATION

This patent application claims priority to U.S. Patent Application Ser. No. 61/886,912 filed Oct. 4, 2013 which is hereby incorporated herein by reference in its entirety.

### BACKGROUND

The subject matter disclosed herein relates to a deployable camera system and, more particularly, to a deployable camera system for an automotive back up camera utilizing a solenoid.

Reverse-direction driving of vehicles is often a difficult skill for a driver to learn. A major source of the difficulty is the requirement that the driver see the area behind the vehicle before driving in reverse. To do this, the driver must use his rear-view and side mirrors or he must turn completely around. In either case, the driver's viewing angle may be limited and the driver may be uncomfortable and confused by what he sees.

One solution to this problem has recently been introduced and involves the use of deployable camera systems. These systems are generally installed in the rear of a vehicle and include a camera and a deploying system. The camera is configured to generate an image of an area behind the vehicle, which is viewable by the driver on a display mounted on the vehicle dashboard or center console. The deploying system maneuvers the camera into rear-viewing position whenever the vehicle is placed into reverse and retracts the camera when the vehicle is placed into drive. Normally, the camera is hidden within some rear portion of the vehicle and is only exposed during reverse driving.

Presently, many deployable rear-view camera systems utilize motor driven gears that are coupled to a lever arm to perform the action of deploying and retracting the rear-view camera. These systems can be costly to build and maintain and may be heavy. Accordingly, it can be desirable to provide a deployable camera system for an automotive back up camera that does not include or utilize motor driven gears coupled to a lever arm.

### SUMMARY OF THE INVENTION

In one exemplary embodiment of the invention, a deployable camera system for a vehicle is provided and includes a camera movably mounted to the vehicle and a solenoid operably coupled between the camera and the vehicle.

In another exemplary embodiment of the invention, a deployable rear-view camera system for a vehicle is provided and includes a housing disposed to occupy and move between stowed and deployed positions relative to a vehicle body, a camera disposed on the housing and a solenoid coupled to the housing and configured to cause the housing to move between the stowed and deployed positions upon an activation thereof

In yet another exemplary embodiment of the invention, a vehicle including a body having a rear portion and a deployable rear-view camera system is provided. The system includes a housing disposed to occupy and move between stowed and deployed positions relative to the body, a camera disposed on the housing and a solenoid coupled to the housing and configured to cause the housing to move between the stowed and deployed positions upon an activation thereof

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a schematic illustration of a vehicle;

FIG. 2 is a side view of a deployable camera system for the vehicle of FIG. 1 in accordance with embodiments;

FIG. 3 is a schematic side view of a deployable camera system for the vehicle of FIG. 1 in accordance with embodiments;

FIG. 4 is a schematic side view of a deployable camera system for the vehicle of FIG. 1 in accordance with alternative embodiments;

FIG. 5 is a view of a solenoid-to-lever arm assembly of the deployable camera system of FIG. 2, 3 or 4 in accordance with embodiments; and

FIG. 6 is a view of a solenoid-to-lever arm assembly of the deployable camera system of FIG. 2, 3 or 4 in accordance with another embodiment.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

As will be described below, a deployable camera system is provided for a rear-vision camera and includes a linear solenoid. The deployable camera may be configured to open in less than 1 second as a result of solenoid activation and is lighter in weight, less costly and simpler than gearing configurations commonly associated with deployable rear-vision cameras.

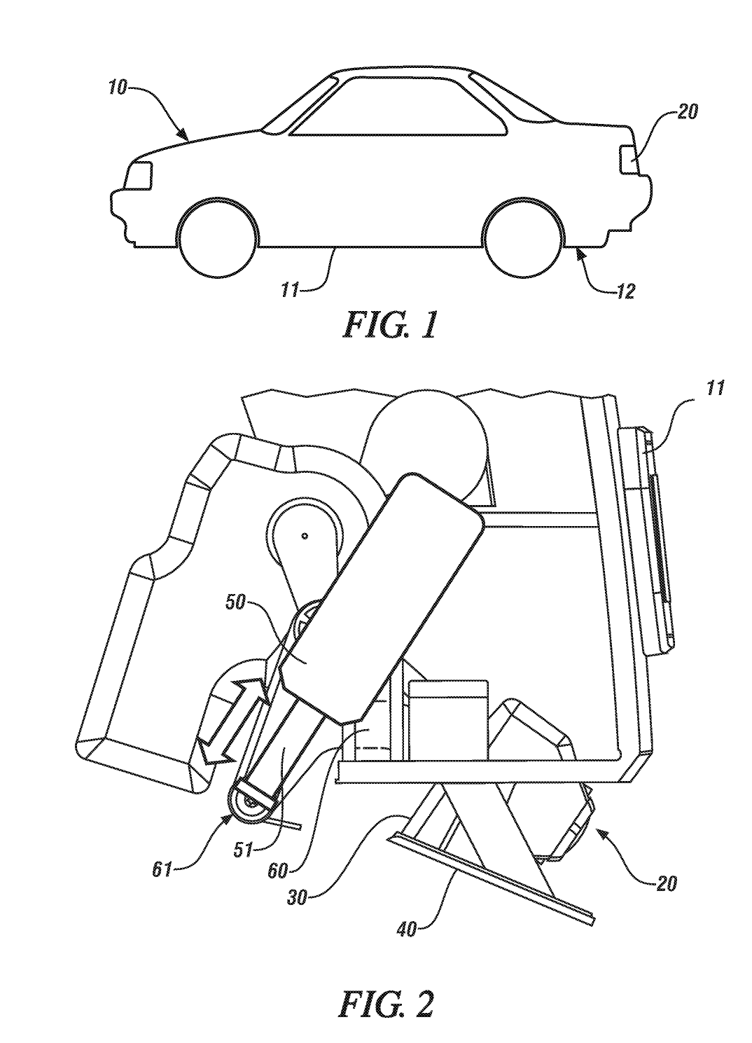

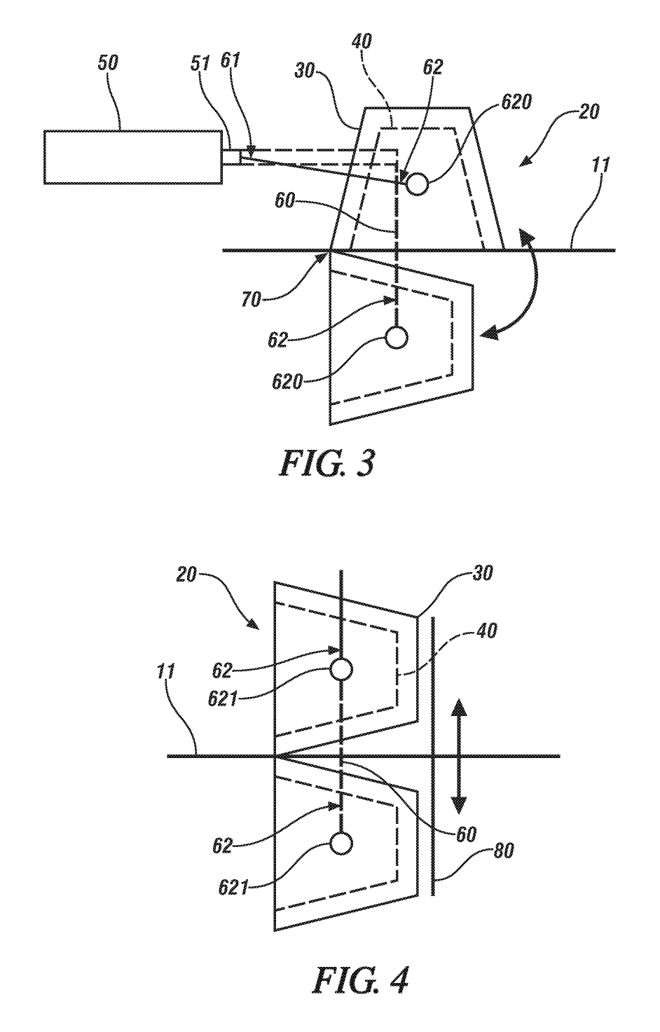

With reference to FIGS. 1-4, a vehicle 10 is provided and includes a body 11 having a rear portion 12 and a deployable rear-view camera system 20. The system 20 includes a housing 30, a camera 40, a solenoid 50 (FIGS. 2-3) and a lever arm 60. The housing 30 may be formed of molded materials, such as plastics or the like, and is disposed to occupy and move between a stowed position relative to the rear portion 12 of the body 11 and a deployed position relative to the rear portion 12 of the body 11. The camera 40 is disposed on or in the housing 30 and is configured to generate a video image of an area of a predefined size behind the vehicle 10 during a reverse-driving condition. In accordance with embodiments, the reverse-driving condition is in effect anytime the vehicle 10 is placed in a reverse driving gear.

With reference to FIGS. 2-6, the solenoid 50 may be provided in various forms and configurations. In general, the solenoid 50 includes a solenoid housing, a plunger 51 (FIGS. 2-3) movably disposed in the housing and a conductive element disposed around the plunger 51. In some cases, the solenoid 50 may further include a biasing element (e.g., a spring) to bias the plunger 51 in a given direction. When the solenoid 50 is activated, current is applied to the conductive element and induces an electromagnetic force on the plunger 51 that causes the plunger to extend or retract based on the direction of the electromagnetic force. Where the solenoid 50 includes the biasing element, the electromagnetic force may be directed in opposition to the bias applied to the plunger 51 by the biasing element. In accordance with embodiments, full extension of the plunger 51 from the fully retracted position may take 1 second or less when the vehicle 10 is placed into a reverse-driving gear. Similarly, full retraction of the plunger 51 from the fully extended position may take 1 second or less when the vehicle is placed in a forward-driving gear.

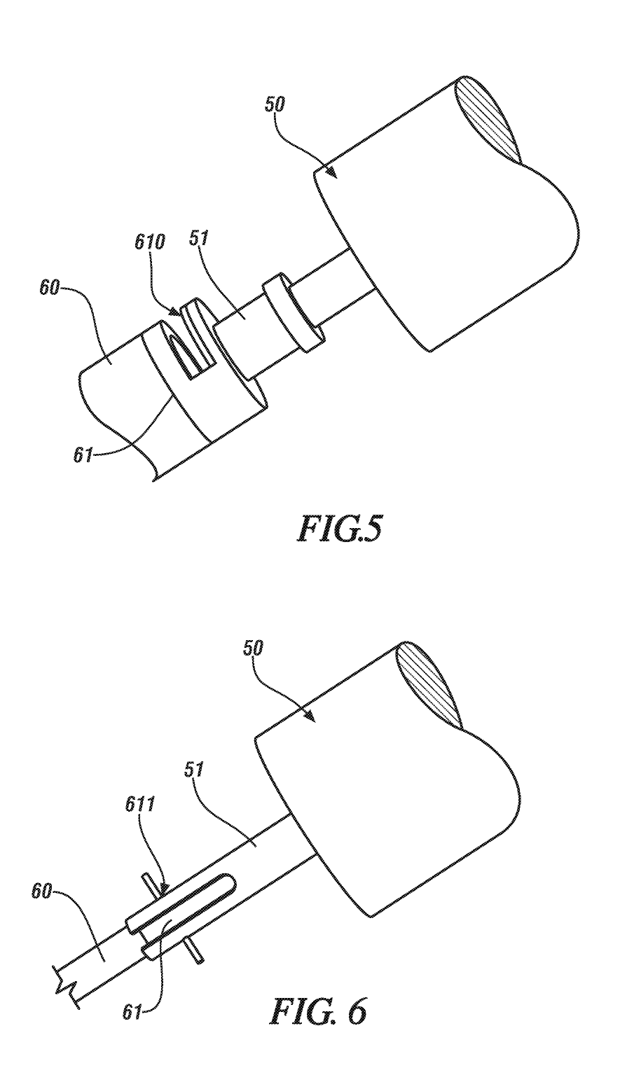

The solenoid 50 is coupled to the housing 30 by way of the lever arm 60. More particularly, the lever arm 60 may include a first end 61 (FIGS. 2-3) and an opposite second end 62 (FIGS. 3-4). In accordance with exemplary embodiments, the first end 61 may be rotatably or non-rotatably coupled to a plunger 51 of the solenoid 50 by way of a wishbone configuration 610 (see FIG. 5) or by way of a pin connection 611 (see FIG. 6). In accordance with further exemplary embodiments, the second end 62 of the lever arm 60 may be coupled to the housing 30 by way of a rotatable hinge-pin connection 620 (see FIG. 3) or by way of a non-rotating connection 621 (see FIG. 4). It is to be understood that the embodiments of FIGS. 3 and 4 and of FIGS. 5 and 6 can be interchangeable with one another and replaced by other similar features.

The solenoid 50 is configured to be activated when the vehicle 10 is placed into a reverse-driving condition and when the vehicle 10 is returned to a forward-driving condition. In the former case, the solenoid 50 is configured to cause the housing 30 to move the camera 40 from the stowed position to the deployed position upon an activation thereof and, in the latter case, the solenoid 50 is configured to cause the housing 30 to move the camera 40 from the deployed position to the stowed position upon an activation thereof. In both cases, the solenoid 50 may be configured to cause the housing 30 to move the camera 40 into and out of the deployed position in less than 1 second following solenoid 50 activation, as noted above.

As shown in FIG. 3 and, in accordance with embodiments, the housing 30 and by extension the camera 40 may be configured to pivot between the stowed and deployed positions about hinge 70. In this case, the activation of the solenoid 50 causes the plunger 51 to extend or retract and the rotatable hinge-pin connection 620 causes the housing 30 to pivot about the hinge 70. At full plunger 51 retraction, the housing 30 and the camera 40 are stowed within the body 11 and at full plunger 51 extension the housing 30 and the camera 40 are deployed at an exterior of the body 11.

As shown in FIG. 4 and, in accordance with embodiments, the housing 30 and by extension the camera 40 may be configured to translate or move linearly between the stowed and deployed positions along a guiding structure 80. In this case, the activation of the solenoid 50 causes the plunger 51 to extend or retract and the non-rotating connection 621 causes the housing 30 to translate linearly along a length of the guiding structure 80. As above, at full plunger 51 retraction, the housing 30 and the camera 40 are stowed within the body 11 and at full plunger 51 extension the housing 30 and the camera 40 are deployed at an exterior of the body 11.

Although not described above, it will be understood that the housing 30 and the camera 40 may be moved between the stowed and deployed positions by way of a combination of pivoting and translating movements. In addition, once the housing 30 and the camera 40 are deployed, the camera 40 may be configured to rotate about 1 or more axis in order to focus its generated image on a particular field. This rotation of the camera 40 may be achieved with or independently of the housing 30. In the latter case, the independent rotation of the camera 40 can be driven by further driving elements disposed within the housing 30.

Although the system 20 is described above as being a rear-view camera system 20, it is to be understood that this is not required and that other configurations for the system 20 are possible. These include side-view camera systems that are disposed on the sides of vehicles and front-view camera systems that are disposed in a front portion of the vehicle. In each of these cases, the camera 40 may be coupled to a display device mounted in the dashboard or center console of the vehicle 10 where the driver can see what is being imaged. Alternatively, the camera 40 may be coupled to an on-board computing device such that images generated by the camera can be analyzed and employed in proximity alarms.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A deployable camera system for a vehicle, comprising:
a camera movably mounted to the vehicle; and
a solenoid operably coupled between the camera and the vehicle.

2. The deployable camera system according to claim 1, wherein the solenoid is configured to move the camera between stowed and opened positions in less than 1 second.

3. The deployable camera system according to claim 1, further comprising:
a housing disposed to occupy and move between stowed and deployed positions relative to a vehicle body, the camera being disposed in the housing and is at least partially exterior to the vehicle body when the housing occupies the deployed position; and
a lever arm by which the housing is coupled to the solenoid.

4. The deployable camera system according to claim 3, wherein the housing is disposed to occupy and move between the stowed and deployed positions relative to a rear of the vehicle body.

5. The deployable camera system according to claim 3, wherein the housing pivots between the stowed and deployed positions.

6. The deployable camera system according to claim 3, wherein the housing translates between the stowed and deployed positions.

7. A deployable rear-view camera system for a vehicle, the system comprising:
a housing disposed to occupy and move between stowed and deployed positions relative to a vehicle body;
a camera disposed on the housing; and
a solenoid coupled to the housing and configured to cause the housing to move between the stowed and deployed positions upon an activation thereof

8. The system according to claim 7, wherein the solenoid is configured to cause the housing to move into the deployed position in less than 1 second following solenoid activation.

9. The system according to claim 7, further comprising a lever arm by which the housing is coupled to the solenoid.

10. The system according to claim 7, wherein the housing is disposed to occupy and move between the stowed and deployed positions relative to a rear of the vehicle body.

11. The system according to claim 7, wherein the housing pivots between the stowed and deployed positions.

12. The system according to claim 7, wherein the housing translates between the stowed and deployed positions.

13. The system according to claim 7, wherein the activation of the solenoid is associated with a reverse-driving condition of the vehicle.

14. A vehicle comprising a body having a rear portion and a deployable rear-view camera system, the system comprising:
a housing disposed to occupy and move between stowed and deployed positions relative to the body;
a camera disposed on the housing; and
a solenoid coupled to the housing and configured to cause the housing to move between the stowed and deployed positions upon an activation thereof

15. The vehicle according to claim 14, wherein the solenoid is configured to cause the housing to move into the deployed position in less than 1 second following solenoid activation.

16. The vehicle according to claim 14, wherein the system further comprises a lever arm by which the housing is coupled to the solenoid.

17. The vehicle according to claim 14, wherein the housing is disposed to occupy and move between the stowed and deployed positions relative to the rear of the body.

18. The vehicle according to claim 14, wherein the housing pivots between the stowed and deployed positions.

19. The vehicle according to claim 14, wherein the housing translates between the stowed and deployed positions.

20. The vehicle according to claim 14, wherein the activation of the solenoid is associated with a reverse-driving condition.
